(19) United States
(12) Patent Application Publication
(10) Pub. No.: US 2025/0046500 A1
(43) Pub. Date: Feb. 6, 2025

(54) AN ARRAY COMPRISING THE WINDING OF CONDUCTORS IN THE FORM OF A STRUCTURE, SUCH AS A TAPE, FOR ANY CANTED COSINE THETA (CCT) MAGNET, WITH ANY MULTIPOLE LAYOUT

(71) Applicant: Michail Koratzinos, Tannay (CH)

(72) Inventor: Michail Koratzinos, Tannay (CH)

(21) Appl. No.: 18/719,413

(22) PCT Filed: Dec. 7, 2022
(86) PCT No.: PCT/GR2022/000068

§ 371 Date: Jun. 13, 2024

(30) Foreign Application Priority Data
Dec. 15, 2021 (GR) 20210100878

(51) Int. Cl. H01F 6/06

(52) U.S. Cl. CPC H01F 6/06

(57) ABSTRACT

An array comprising the winding of conductors in the form of a structure, incorporating a tape, for any Canted Cosine Theta (CCT) magnet, with any multipole layout, in which the tape trace of the conductor of a CCT magnet in a plane perpendicular to the length of the magnet is a “Race Track” and not a circle as in the conventional CCT case. This Race Track includes straight and curved segments equal in number to twice the order series of the basic multipole (e.g., two for a dipole, four for a quadrupole, six for a sextuple, etc). The advantages of this invention are that in this way it becomes possible to make a CCT magnet with High Temperature Superconductor tapes, thus, any magnet, and therefore, also, a motor and a generator.

### REFERENCE DATA

The present patent application is a national phase of international patent application PCT/GR2022/000068 of 7 Dec. 2022, claiming priority of Greek patent application GR20210100878 of 15 Dec. 2021, the contents whereof are hereby incorporated by reference in their entirety.

### DESCRIPTION

The current invention solves the problem of the winding of High Temperature Superconductors (HTS), in the form of a tape, in magnets of the Canted Cosine Theta (CCT) type.

The state-of-the-art for the winding of CCT magnets today does not allow the winding of HTS tapes. The present invention modifies the way the windings are defined and allows the use of HTS tapes. It is based on a modification of the definition of the CCT winding shape in the plane perpendicular to the length of the magnet, from a circle to a “Race Track” pattern, made up of straight and curved segments.

### PRIOR ART

CCT electromagnets, also known as “double-helix” magnets, are based on a design where a groove is cut in a mechanical support structure, the “magnet former”, which precisely determines the position of the cable-conductor and the current flow, which determine the characteristics of the magnet. The magnetic field is created inside the magnet former, which is hollow. The equations defining the position of the groove (and, therefore, of the conductor), are given below. The first mention of CCT magnet design can be found in the 70s. CCT magnets started becoming popular among magnet designers during the current decades (2010-2020), due to the advent of automated lathe techniques, (CNC machines) and 3D printers, as well as due to their simplicity, excellent magnetic quality, low-cost and speed of construction.

### PRIOR ART AND INITIAL DESCRIPTION

The current invention introduces a new winding array that allows High Temperature Superconductor (HTS) Tapes to be used in a Canted Cosine Theta (CCT) magnet former. Furthermore, a new design of the CCT magnet former in a way that allows for such a specific winding becomes possible. Without it, it is impractical to build a CCT magnet with HTS conductors.

HTS materials offer high efficiency compared to traditional low-temperature superconductor materials and are now increasingly used. However, the usual form of HTS superconductors is HTS Tapes and not the traditional conductors of cylindrical cross-section (cables). These tapes are usually 4-12 mm wide, 50-100 microns thick and can have a length of up to many kilometers.

Tapes differ from the traditional conductors of cylindrical cross-section by the fact that they are flexible in the direction parallel to their width, but very rigid and fragile in the direction parallel to their thickness.

In order to achieve higher magnetic fields and given the fact that HTS tapes are very thin, a stack of tapes can be used. The invention refers to stacks of HTS tapes, including the stack of one (single strip).

The magnetic field of a magnet, in a plane perpendicular to its long dimension, is characterized by a mixture of skew and normal multipole components. Multipoles are dipoles, quadrupoles, hexapoles, and so on. Most magnets have a main multipole component with all others being a lot weaker, (of the order of one thousandth of the strength of the main multipole, or less), which represent magnetic defects.

CCT magnets have a groove in a hollow-shaped former in the shape of a hollow cylinder, the centre of which at the lowest point is given by the equation

$$x = R cos θ ; y = R sin θ ; Z = {\sum }_{{n}_{B}} [ \frac{R sin ( {n}_{B} θ )}{{n}_{B} tan {α}_{n B}} + \frac{ω θ}{2 π} ] + {\sum }_{{n}_{A}} [ \frac{R cos ( {n}_{A} θ )}{{n}_{A} tan {α}_{n A}} + \frac{ω θ}{2 π} ] \qquad ( 1 )$$

Where R is the radius of the coil and n_{A} and n_{B} are the skew and normal multipole orders. The order number 1 represents a dipole magnetic field, 2 quadrupole, 3 sextuple, and so on. The angles α_{nA} and α_{nB} are the minimum angles of the groove with respect to the vertical plane (x, y) per desired multipole, (called the skew angles). They are inversely proportional to the strength of that component. An angle of 90 degrees would ensure no relevant multipole component, whereas the minimum angle, (that gives the maximum multipole field), is limited by practical considerations, (the groove cannot run onto itself), to about 25 degrees. ϑ is the winding angle and runs from 0 to 2πnₜ where nₜ is the number of turns. ω is the conductor pitch, (the distance between successive windings).

In the limit where conductor size is very small compared to R (i.e. the grove has zero width and depth and the conductor is, simply, a line), the resulting field of an infinitely long magnet away from the edges, is a perfect reflection of the mix of multipoles of equation [1], with no multipole errors.

The most common magnets are dipoles, (all angles α are π/2 except for n_{B}=1), quadrupoles (all angles α are π/2 except for n_{B}=2) and sextuples (all angles α are π/2 except for n_{B}=3). A CCT magnet, in addition to the main multipole, can be designed to contain also small amounts of other multipoles.

Since this arrangement produces also a field along the longitudinal (z) direction, which is unwanted in most cases, a second CCT layer with a slightly increased R, depending on the thickness of the former, opposite winding direction and a skew angle of opposite sign is incorporated. The start of the outer layer and the end of the inner layer are located on top of one another. This second layer has the same current flowing in the opposite direction than the first layer. The result is that the longitudinal fields of the two layers cancel, and the intended multipole contributions have the same sign. Sometimes the CCT design is referred to as “double helix” due to the two layers. In any case, the two layers are identical in concept so we will only refer to one layer here. The exact same method can be incorporated in the other layer.

According to equation [1], in the (x, y) plane, the groove describes a circle and in three dimensions it is located on the surface of a cylinder. In zθ space, the groove describes a sine curve for a specific multipole.

Recently, some CCT magnets follow a curved path, where the centre of the magnet (which in equation [1] lies at (x, y)=(0,0)) describes a circle in the (x, z) plane with radius R_{curved} where R_{curved}>>R.

Garcia Fajardo, et al. (2021), in “First Demonstration of High Current CCT coils with Bi-2212 Rutherford Cables”, discloses conductors of round cross-section and Rutherford cables which comprise round conductors. U.S. Pat. No. 6,921,042 discloses a similar combination.

CCT coils are disclosed also by Peng Quanng, at al. (2020), in “Harmonic Suppression study on Twin Aperture CCT Type Superconducting Quadrupole for CEPC Interaction Region”.

US 2021/350 957 A1, discloses-high-temperature superconductor tapes.

WO 2012/117249 A1 discloses a magnet with concentric tubular coils having elliptical cross-section.

US 2011/279215 A discloses a wiring assembly having a conductor positioned about an axis in a helical-like configuration to provide a repetitive pattern which rotates around the axis.

### CCT Magnet Winding for HTS Tapes: The Present Invention

One preferred embodiment of the invention comprises the following parts and features:
1. High Temperature Superconductor (HTS) tape (1)
2. Magnet former (2)
3. Tape trace (3)
4. Straight Segment(s) (4)
5. Curved segment(s) (5)
6. Enclosed radius of curvature (6)
7. Winding angle [symbol] (7)

The following Figures are attached to the current Description:

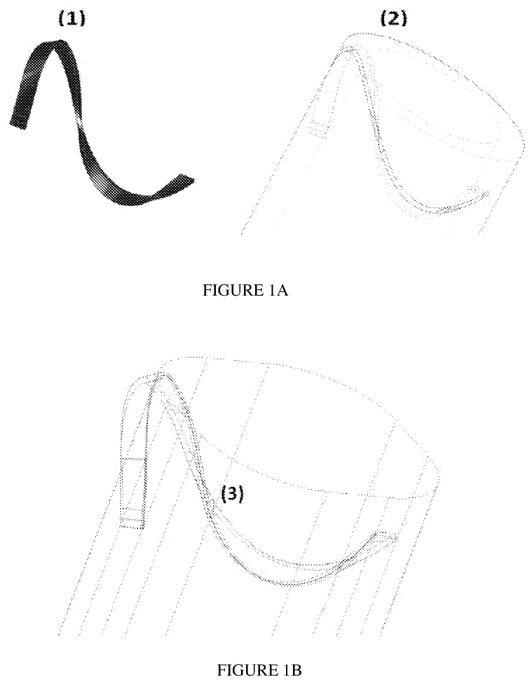

FIG. 1A: a stack of HTS tapes (1), (dark colour, left), following the groove in a Magnet former (2) of a quadrupole CCT magnet (right). Half a turn is shown, and the stack of tapes is shown separately from the magnet former.

FIG. 1B: transparent sketch of a stack of tapes (half turn) and the tape trace (3) (the black line) following a “Race Track” CCT path.

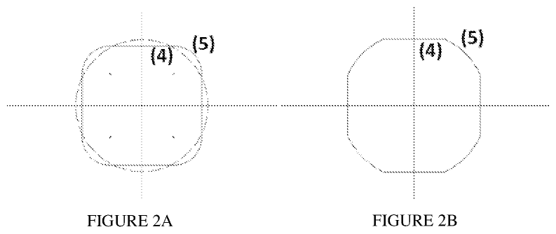

FIG. 2A: the geometric site of the HTS tape trace (3) in the (x, y) plane forms a “Race Track” shape (solid line), compared to the conventional type of CCT design which is a circle (dashed line). This “Race Track” consists of a number of straight segments (4) and curved segments (5). This example is for a quadrupole magnet and the dimensions are exaggerated for illustration purposes. The “Race Track” for a dipole has two straight segments, for a quadrupole four, for a sextuple six, etc.

FIG. 2B: alternative design (one of many) where the centres of the arcs are at the same point, at (0, 0).

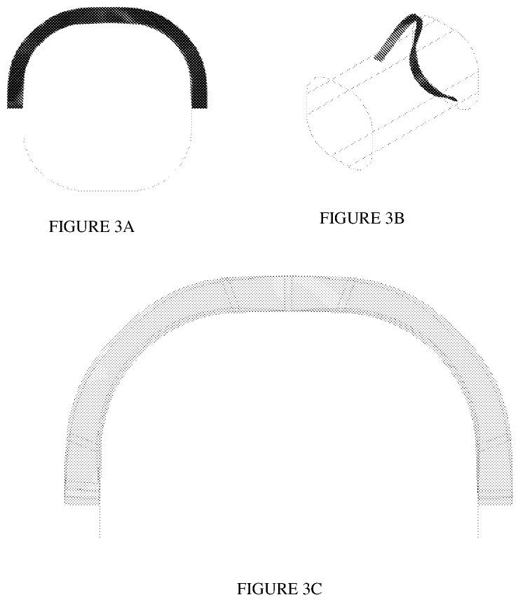

FIGS. 3A and 3B: the current invention uses a “Race Track” profile instead of a circular shape as a tape trace (3) in the (x, y) plane, projection in the (x, y) plane in 3A, isometric view in 3B. Half a turn of the HTS tape stack is visible. (A typical magnet has many turns).

FIG. 3C: same as 3A, transparent sketch. The tape trace (3) can be seen. It has the shape of a “Race Track” with curved segments connected by straight segments.

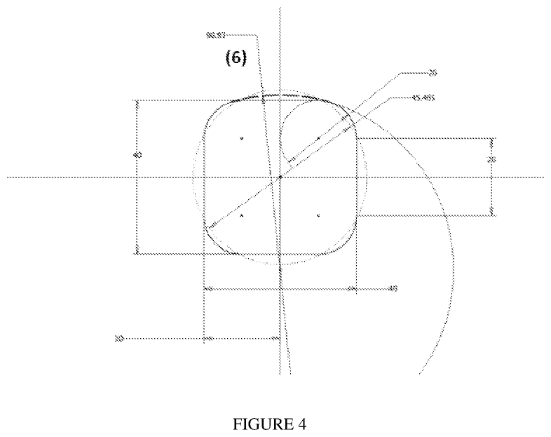

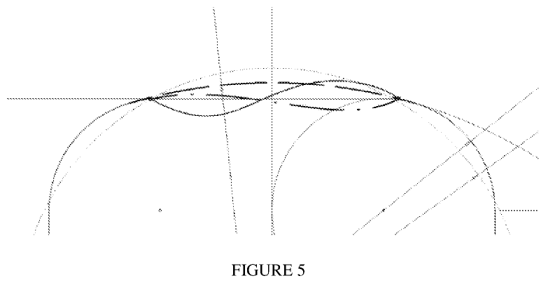

FIG. 4: The straightness requirement of the straight segments (4) of the “Race Track” in this invention, with a specific example for easier understanding. The “Race Track” CCT design of a quadrupole is shown in the xy plane projection (solid line). This is the projection of the tape trace (3) in the (x, y) plane. The straight segments have lengths of 20 mm, and the convex segments are formed by circles with a diameter of 20 mm. The total width of the “Track” is 40 mm, and the circumference is indicated by the dotted line. This leads to an average diameter of 45.46 mm and the average radius Rₘₑₐₙ=22.73 mm. A curve appears for the straight-line segment at the top (dashed line), where the curvature diameter is 90.93 mm.

### DETAILED DESCRIPTION

Formula [1] in the previous section works perfectly for a flexible conductor such as a thin wire of cylindrical cross-section. However, the HTS conductors, as mentioned above, come with the form factor of a tape of a few millimetres wide, (4 to 12 mm), and a thickness of a few tens of micrometers (50-100 μm). Due to the large difference size in the two directions, a tape exhibits great directionality as it can bend with very little effort around the direction parallel to its width, but it cannot bend, (exhibits very high stiffness), around the direction parallel to its thickness. The same applies to stacks of tapes. Forcing a tape to bend in the plane of high stiffness beyond the elastic limit might result in damaging the tape and possibly to a loss of superconducting performance.

The CCT formula described in [1] applies to a line and not a solid object. A round conductor whose diameter is much smaller than the radius R of the magnet can be approximated very well by a line. A tape, however, in general, cannot. The tape trace (3) is defined as the centre of one edge, or of the middle of the stack of tapes. This edge is taken to be the one closest to the centre of the magnet, (defined along the line (x, y)=(0,0) ((3) in FIG. 1B), however, the exact same arguments apply if the edge is the one furthest away from the centre of the magnet, or the middle of the tape. The tape trace (3) is the one that follows equation [1].

When a tape, or stack of tapes, tries to follow a curved path on the surface of a cylinder, it buckles, and the tape is no longer perpendicular to the surface of the cylinder at all times. Successive bends, as in the case of the CCT, require the stack of tapes to change from a positive bending radius (concave) to a negative radius (convex), as shown in FIG. 1A. Between two successive turns the tape must twist. However, twisting while following a curved surface is generally not possible, as it requires bending along the non-bending axis of the tape.

The present invention uses a “Race Track” shape for the geometric site of the tape trace (3) in the (x, y) plane, (which in the case of equation [1] is a circle for a conventional CCT magnet), as shown in FIG. 2. Straight Segments (4) are joined by curved segments (5), for example, circle arcs. The centres of these circles may be different from the centre of the magnet, as in FIG. 2A, or coincide as in FIG. 2B, or have any other shape. The straight segments enable the tape to twist between concave and convex bends, which is not possible if there is only one circular segment as in the conventional CCT magnet.

The number of straight segments (4) is equal to twice the order series of the basic multipole of the magnet: (two straight segments for a dipole, four for a quadrupole, six for a sextuple, etc.). Straight segments give the opportunity to the stack of tapes to twist, ready for the next bend. These straight segments (4) are located around the tape twisting points of the design around the areas where sin(n_{B} θ)=0 for normal multipoles and cos(n_{A} θ)=0 for skew multipoles, where [symbol] is the winding angle and n_{A} and n_{BA} is the order number of the skew and normal multipoles (n_{A}, n_{B}=1, 2, 3, . . . ).

FIG. 3 shows the design of the “Race Track” of this invention in the case of a quadrupole; the projection on the (x, y) plane, as well as the isometric view are displayed; a small part of the stack of HTS tapes, (half a turn), is displayed, but the principle described here applies everywhere along the conductor.

A circle is fitted to the plane that encloses exactly the projection, and at the same time touches the curved segments (5), before and after the straight part and its radius is noted. This is the enclosed radius of curvature (6) of the projection of the straight segments (4) in the plane perpendicular to the length of the magnet.

1-4. (canceled)

5. A modified Canted Cosine Theta (CCT) magnet with a dipole or multipole layout, comprising a winding having a stack of conductor tapes, wherein a projection of a trace of the conductor tapes in a plane perpendicular to the length of the magnet is made up of straight segments joined by curved segments.

6. The modified CCT magnet of claim 5, wherein the conductor tapes are high-temperature superconductor tapes.

7. The modified CCT magnet of claim 6, wherein the conductor tapes are wound upon a hollow former in a groove thereof.

8. The modified CCT magnet of claim 5, wherein the number of straight segments is two straight segments for a dipole, four for a quadrupole, and six for a sextuple.

9. The modified CCT magnet of claim 5, wherein the number of straight segments is twice the order number of the basic multipole of the magnet.

10. The modified CCT magnet of claim 5, wherein a length of the straight segments is greater than, or equal to, a width of the conductor tapes.

11. The modified CCT magnet of claim 5, wherein an axis of the straight segments is at an angle with respect to the length of the magnet.

12. A method of using the modified CCT magnet of claim 5 in an external magnetic field, comprising generating a current in the conductor tapes by the external magnetic field.
